(19) United States
(12) Patent Application Publication
(10) Pub. No.: US 2026/0261056 A1
(43) Pub. Date: Sep. 3, 2026

(54) CONTACTING DEVICE, CABLE, CONNECTION SYSTEM, AND METHOD FOR MANUFACTURING A CONNECTION SYSTEM

(71) Applicant: Murrelektronik GmbH, Oppenweiler (DE)

(72) Inventors: Olaf PREIN, Lügde-Rischenau (DE); Marco BOSCH, Weilheim a. d. Teck (DE); Heiko FEISST, Schlierbach (DE); Andreas SCHUFFENHAUER, Chemnitz (DE); Christian KÜBLER, Backnang (DE)

(73) Assignee: Murrelektronik GmbH, Oppenweiler (DE)

(21) Appl. No.: 19/553,576

(22) Filed: Mar. 2, 2026

(30) Foreign Application Priority Data
Mar. 2, 2025 (DE) 10 2025 107 845.9

(51) Int. Cl. H01R 4/2406; H01R 13/02; H01R 13/627; H01R 13/639; H01R 43/26

(52) U.S. Cl. CPC H01R 4/2406; H01R 13/025; H01R 13/6271; H01R 13/639; H01R 43/26

(57) ABSTRACT

The invention relates to a contacting device (100) for the specific electrical contacting of electrical conductors (201) of an electrical cable (200) that are twisted together, wherein the contacting is performed, in particular predominantly or exclusively, by inserting a plurality of contact means (102) into the electrical conductors (201) at a contact surface (205) of the cable (200). The invention also relates to a cable (200), a connection system (300), and a method (400) for manufacturing a connection system (300).

### RELATED APPLICATIONS

This application claims the benefit of priority of Germany Patent Application No. 10 2025 107 845.9 filed on March 2, 2025, the contents of which are all incorporated by reference as if fully set forth herein in their entirety.

### FIELD AND BACKGROUND OF THE INVENTION

The present invention relates to a contacting device, a cable, a connection system, and a method for manufacturing a connection system.

Contacting devices may have contact means for electrically contacting electrical conductors of cables. There are contacting devices that ensure specific alignment of the contact means with the conductors. However, if the conductors of the cable are twisted together, there is often a risk that, in addition to the intended conductors, other conductors of the cable will also be electrically contacted unintentionally, which can lead to malfunctions.

Publication DE 196 11 127 C1 discloses a connection arrangement for contacting a cable, wherein the conductors of the cable extend in a straight line along the cable.

### SUMMARY OF THE INVENTION

Embodiments of the present disclosure are directed to provide an alternative or better technical solution that preferably overcomes the disadvantages of the prior art, in particular avoiding faulty contacts and/or miswiring.

The above-described issues are addressed by a contacting device, a cable, a connection system, and a method for manufacturing a connection system with the features of the corresponding independent claims. Further features and details of the invention are apparent from the respective dependent claims, the description, and the drawings. Of course, the features and details described in connection with the contacting device according to the invention also apply in connection with the cable according to the invention, the connection system according to the invention, the method for manufacturing a connection system according to the invention, and vice versa, so that mutual reference is or can be made to the disclosure of the individual aspects of the invention.

The contact device according to the invention relates to a contacting device for the specific electrical contacting of electrical conductors of an electrical cable that are twisted together.

The contacting device may comprise a plurality contact means, in particular piercing means, for electrically contacting each electrical conductor, in particular stranded conductor, of the cable by means of one of the contact means, in particular the same contact means, at a contact surface which is formed at an end of the cable.

Furthermore, the contact means, in particular a configuration and/or arrangement and/or direction of extension of the contact means, preferably depending on the twisting of the conductors, may be configured in such a way that, a contacting movement for contacting the electrical conductors by means of the contact means, is initiated, in particular predominantly or exclusively, by the multiple contact means piercing the electrical conductors at the contact surface of the cable.

Furthermore, it is possible that the contact means, in particular a configuration and/or arrangement and/or direction of extension of the contact means, preferably depending on the twisting of the conductors, are configured and, in particular, designed and/or arranged in such a way that the contacting movement for contacting the electrical conductors by means of the contact means is initiated, in particular predominantly or exclusively, preferably by piercing the multiple contact means into the electrical conductors, preferably at (i.e., in particular in the spatial area of) the contact surface of the cable.

The contacting movement may comprise a movement of the cable and/or the contact means. Furthermore, the contacting movement may comprise an axial movement in the direction of the longitudinal extension (i.e., the axial direction) of the cable and/or at least partially rotational and/or at least partially helical movement. The multiple contact means can be inserted into the electrical conductors at the contact surface and thus preferably through the contact surface. The contacting movement can take place accordingly at the contact surface, e.g., penetrating a plane that extends parallel to the contact surface.

The contact means may have a configuration and/or extension and/or shape and/or orientation and/or curvature that at least partially follows a trajectory of the contacting movement.

The contact means may have a configuration that facilitates the contacting movement and may thus be configured in such a way that the contacting movement can be performed. This means, for example, that the contact means are configured in relation to the contacting movement as guide means which, once they have been inserted into the conductor, guide the contacting movement. Since the guidance provided by the contact means may not be sufficient on its own (the contact means could otherwise easily penetrate the insulation of the conductor), at least one additional guiding means may be provided for this purpose.

The contact means may, for example, be deflected at a specific angle from an imaginary longitudinal axis of the contacting device, which corresponds to the longitudinal axis (in the axial direction) of the cable when in the contacted state, and thus have an oblique position relative to this longitudinal axis. The angle may be the same for all contact means. The contact means may also be arranged along a circular circumference at equal distances from each other. This allows the contact means to “follow” the twisting of the conductors.

In particular, the invention provides an alternative or improved technical solution for contacting electrical conductors in cables, which in particular overcomes the disadvantages of the prior art. This contacting device can be used, for example, to prevent faulty contacting and/or miswiring.

Specific contacting can refer to predetermined and/or targeted electrical contacting, i.e., in particular, target contacting, between individual contact means and individual conductors. Preferably, each contact means is electrically connected and/or contacted with only one electrical conductor.

The contacting preferably comprises (per contact means) a (single) penetration or (single) insertion or a (single) exclusive penetration or a (single) exclusive insertion of the conductors by means of the contact means, preferably in such a way that an electrically conductive contact between the conductors is established by means of the contact means.

The insertion or penetration may be configured in such a way that a contact means inserted into a conductor at one point does not protrude from the conductor at a second point on the conductor. The contact means may thus be configured in such a way that they follow the extension of the conductors in the cable, thereby preventing complete double/two-sided penetration of the conductor.

Exclusive penetration is therefore preferably understood to mean purely piercing the conductor without any cutting movement. The term “exclusive” insertion preferably means that a contact means inserted into a conductor at one point does not protrude from the conductor at a second point on the conductor. In other words, the contact means preferably penetrates the surface of the conductor at only one point.

Preferably, the contact means extend within the respective conductor along the corresponding conductor. This ensures the largest possible contact area between the contact means and the respective conductors. Preferably, the contact means are configured and/or aligned to form the largest possible contact area for electrical contact with the respective conductor. Preferably, this formation and/or alignment is dependent on the twisting of the conductors of the cable. This ensures a safe flow of current, which prevents, for example, coking of the contact area due to excessive current per contact area. In general, the term “contact surface” can refer to a surface that is formed by direct physical contact between the contact means and the associated conductor and can be used to conduct electrical currents.

Preferably, the contact means do not extend parallel to each other.

Preferably, the cable may have at least or only two, three, four, or five conductors. Furthermore, a number of contact means corresponding to the number of conductors may be provided. In other words, it is preferable if the number of contact means corresponds to the number of conductors. Irrespective of this, at least or only two, three, four, or five contact means may be provided.

The conductor or conductors may preferably be stranded conductors. This makes the conductors particularly flexible.

All disclosures relating to one of the conductors may also relate to all conductors or part of the conductors, in particular with regard to the associated contact means or contact means, and vice versa.

All disclosures relating to one of the contact means may also relate to the piercing means, all piercing means, part of the piercing means, all contact means, or part of the contact means, in particular with regard to the associated conductor or conductors, and vice versa.

Preferably, there are at least or only two, three, four, or five conductors, in particular twisted together.

The contact surface is preferably formed at one end of the cable. In other words, the contact surface preferably forms one end of the cable. The contact surface is preferably a cut surface at which the cable has been shortened to a target length. The contact surface preferably runs transversely or perpendicularly to the direction of extension of the cable. The conductors preferably extend only up to the contact surface.

The contact surface can generally be understood to be an area of the cable up to which the conductors of the cable extend and/or at which the conductors end. Preferably, it is an area at which the conductors have access to the environment of the cable. In other words, it is preferable if the contact area is the area into which the contact means are inserted, in particular pierced, into the conductors and/or the cable during the contacting movement. Preferably, the contact area is not the sheath or a sheath of the cable.

The contact means may be configured as a piercing means, which preferably means that the contact means has a piercing tip, in particular for penetrating the sheath and/or the conductor. Furthermore, the configuration as a piercing means can mean that the piercing means is configured without cutting edges. This prevents the conductor to be contacted, in particular strands of the stranded conductor, from being cut through, especially if the contact means can only or predominantly be pierced into the conductors.

“Predominantly pierceable” preferably means that the insertion of a contact means into the cable and/or conductor consists of more than 50% piercing, while the remainder, i.e., in particular a smaller proportion, consists of cutting the contact means into the cable and/or conductor. The aforementioned proportions can be determined on the basis of the insertion paths, in particular piercing paths and/or cutting paths, preferably in relation to the insertion path.

The contacting movement can preferably mean that the contact means, in particular unchangeable, are arranged stationary in the contacting device and may be inserted or are insertable into the cable by inserting the cable into the contacting device or by moving it toward the contact means.

Furthermore, it is preferable if the contact means extend to a plane that is perpendicular to the direction of extension of the cable and/or perpendicular to an insertion direction of the cable into the contacting device and/or in which the contact surface lies, in particular at an acute angle. The acute angle is preferably an angle that is less than 90°, 80°, 70°, or 60°.

To insert the cable into the contacting device, the contacting device preferably has an insertion opening. The insertion opening preferably has a shape that matches the outer contour of the cable. Preferably, the insertion opening has a guide for the cable. Irrespective of this, it is preferable if the insertion opening has a counter-coding that matches a coding of the cable in order to ensure specific electrical contacting. Preferably, the counter-coding is the guide. The guide is preferably configured to guide and/or determine the contacting movement. In addition, the guide is configured to align the cable, in particular the conductors, in relation to the contacting device, in particular the contact means, preferably in accordance with the specific contacting.

Furthermore, it is preferable if the contacting movement comprises a movement of the cable relative to the contacting device in the direction of extension of the cable and/or in the direction of insertion of the cable into the contacting device, and that the contacting movement simultaneously comprises a movement of the cable relative to the contacting device about the direction of extension of the cable and/or about the direction of insertion of the cable into the contacting device. The simultaneous movement is preferably a linear, straight movement in an axial direction and, at the same time, a rotational movement about an axis defined by the axial direction and/or the extension of the cable. The axis preferably passes through a center of area of the cable cross-section. The cable cross-section preferably runs transversely or perpendicularly to the extension of the cable. The cable cross-section may be the contact surface. In other words, the contacting movement may be a helical movement and/or a movement that follows a helical path. The contacting movement may preferably be predetermined by a guide for the cable. Furthermore, the contacting movement, in particular in the relationship between the rotational movement and the linear movement, may be a movement dependent on the twisting of the conductors and the formation and/or alignment of the contact means, in particular in such a way that the electrical contacting of the plurality of contact means into the respective electrical conductors at the contacting surface of the cable can be performed predominantly or exclusively by piercing into the contacting surface and/or the respective conductors.

Furthermore, it is preferable if the contact means, in particular the configuration and/or arrangement and/or dimensioning and/or direction of extension of the plurality of contact means , are adapted to the electrical conductors, in particular the twisting of the electrical conductors and/or a dimensioning of the electrical conductors and/or a routing of the electrical conductors and/or an arrangement of the electrical conductors at the contact surface and/or an extension direction of the electrical conductors at the contact surface, such that electrical contacting of a plurality of electrical conductors by means of only one of the contact means, in particular by one of the contact means electrically contacting a first electrical conductor in the contact surface and a further electrical conductor in the direction of extension of the cable behind or next to the first electrical conductor, preferably due to the twisting of the electrical conductors, is prevented. In this way, incorrect contacting and/or multiple contacting of conductors by means of a contact means is prevented.

Furthermore, it is preferable if the contact means have an extension direction and/or arrangement which is configured in such a way that, when the contact means penetrate the electrical conductors at the contact surface during the contacting movement, the contact means can essentially form an, in particular continuous and/or linear, extension of the electrical conductors adjacent to the contact surface. This extension is preferably formed when the contact means are in contact with the conductors and/or the contact surface, which is the case during the contacting movement. Essentially means, preferably, that the contact means contact the corresponding conductors at the contact surface at an angle between 170° and 180° or 175° and 180°. This is preferably an angle between the respective conductors and the respective contact means at the contact surface.

Furthermore, it is preferable if the contacting device comprises at least one actuating element and a motion converter, wherein an actuating movement can be initiated in the motion converter by means of the actuating element, wherein the actuating movement is a rotational movement, a pressing movement, pulling movement or a pivoting movement, wherein the motion converter is configured to convert the initiable actuating movement into the contacting movement in order to contact the contact means with the electrical conductors, and wherein the actuating element is preferably configured to be ring-shaped or cylindrical or tubular or as a lever. In other words, it is possible to provide means for executing the contacting movement instead of executing the contacting movement manually, i.e., by hand. Preferably, the insertion opening leads through the actuating element.

Furthermore, it is preferable if the contacting device comprises a detent mechanism for the actuating element, by means of which the actuating element can be latched in at least one position, wherein the at least one position corresponds to a penetration depth of the contact means into the cable, and/or wherein the contacting device preferably comprises an indexing means by means of which a penetration depth of the contact means into the cable can be indicated, and wherein the contacting device preferably comprises an adjustment mechanism by means of which a maximum penetration depth of the contact means into the cable may be adjusted.

The detent mechanism may ensure that the contact means penetrates the cable and/or the conductors to the intended depth. The detent mechanism may, for example, provide step-by-step acoustic and/or haptic and/or optical feedback to the operator of the contacting device during the execution of the actuating movement, whereby each step preferably corresponds to a predetermined value for the penetration depth. It is preferable if the at least one actuating element comprises the insertion opening. A maximum penetration depth of the contact means may be preset by means of the adjustment mechanism. The indexing is preferably an index or a display, in particular a scale, which indicates the current penetration depth of the contact means into the cable.

Furthermore, it is preferable if the contacting device comprises a locking mechanism for the cable, in particular for attaching the cable to the contacting device, wherein the locking mechanism is preferably releasable, in particular to release the cable from the contacting device, wherein the attachment is preferably in the form of a force-fit and/or form-fit connection of the cable, in particular a sheath of the cable, with the locking mechanism, and that actuation of the locking mechanism can preferably be performed by means of the actuating element or a further actuating element. The force-fit connection may, for example, be configured as a clamping of the cable. The form-fit connection may be formed between retaining elements of the contacting device and recesses or beads in the sheath of the cable. The recesses or beads on the sheath for forming the form-fit connection may extend at a distance from each other and perpendicular to the extension of the cable. The locking mechanism may be configured as a strain relief for the cable, in particular to secure an electrical contact between the contact means and the conductors. The force-fit connection may be a clamping, in particular a clamping of the cable or the sheath of the cable. Furthermore, the clamping may be configured using clamping means of the locking mechanism. The clamping means may be a seal or the seal described below.

Furthermore, it is preferable if the contacting device comprises at least one seal, preferably a sealing lip, to interact with a sheath of the cable or with the contact surface of the cable in such a way that contacting points at which the contact means are capable of making electrical contact with the electrical conductors, can be sealed by means of the seal to the environment of the contacting device when the electrical contact between the electrical conductors and the contact means is established.

The seal preferably provides a seal in accordance with IP67, in particular in accordance with the meaning on December 1, 2024, with effect for the Federal Republic of Germany.

The seal may clamp the cable in such a way that the seal also acts as a locking mechanism. For this purpose, it is useful if the seal is preloaded or can be preloaded against the sheath. Alternatively or additionally, the seal may serve as a strain relief for the cable in this way.

The seal preferably surrounds the circumference and/or the sheath of the cable and/or is preferably arranged at the insertion opening or associated with the insertion opening.

Furthermore, it is preferable if the contacting device is configured as a plug connector, preferably comprising an electrical socket arrangement or electrical plug arrangement, or as an electrical connection of an electrical component. In this way, the cable may be electrically connected to a plug that fits into the electrical socket arrangement. Alternatively, the cable may be electrically connected to a socket into which the plug arrangement fits. The electrical component is preferably a system from automation technology or another electrical consumer.

Furthermore, it is preferable if the contacting device has a counter-coding for a coding of the cable, wherein the coding and the counter-coding interact in such a way that a specific contacting of the contact means with the conductors is ensured and/or contacting of the contact means with the conductors that deviates from specific contacting is prevented. In particular, despite twisting of the conductors relative to each other, the specific contacting may thus be specified. The coding and the counter-coding are preferably configured as a form fit and/or guide. In addition or alternatively, the counter-coding can be configured to prevent a cable without coding matched to the counter-coding from being inserted into the insertion opening. Without the coding and counter-coding, specific contacting would be significantly more difficult due to the twisting of the conductors relative to each other. Preventing insertion preferably means blocking the insertion of the cable into the insertion opening. In other words, specific contacting may be enforced by means of the coding and counter-coding.

The coding extends, for example as a groove or bead, preferably continuously and/or uninterrupted and/or helically, along the cable. It is preferable if the coding or the coding-forming geometry, which differs from a basic shape, in particular a circular basic shape or outer contour, of the cable, is formed, for example, by a bead or groove on the sheath of the cable. It is also preferable if the coding or the coding-forming geometry has the same relative position to the conductors along the length of the cable.

The invention also relates to a cable for a contacting device according to the invention, wherein the cable preferably comprises a coding, in particular in the form of a continuously extending helical groove or bead on the sheath of the cable, and electrical conductors twisted together, wherein the coding along the cable has the same relative position to the electrical conductors in a plane perpendicular to the direction of extension of the cable, wherein the electrical conductors extend in particular only up to a contact surface formed at one end of the cable. In this way, the cable may be electrically connected to a plug that fits into the electrical socket arrangement. Alternatively, the cable may be electrically connected to a socket into which the plug arrangement fits. The coding may be provided at regular or irregular intervals along the cable or extend continuously along the cable, i.e., in the direction of extension of the cable.

The cable according to the invention thus offers the same advantages as those described in detail with reference to a contacting device according to the invention.

In addition, it is possible for the cable to be configured as a power cable, a data cable, or a hybrid cable. As a hybrid cable, the single cable may be used for both power and data transmission, for example. For this purpose, one or more data lines and one or more power lines are provided, for example. The respective data and/or power line may have an electrical conductor which is surrounded by a sheath, in particular an insulating sheath or shielding. The shielding may be made of an electrically conductive material in order to shield electromagnetic interference, for example. Materials such as copper or aluminum may be used for this purpose. In contrast, the insulating sheath may be made of an electrically insulating material. Materials such as ceramics, glass, or plastics may be used for this purpose. The respective data line may be configured as an electrical or optical data line and preferably as a fieldbus and/or Ethernet line.

The cable and/or component and/or connection system may be configured for Single Pair Ethernet (SPE). Unlike conventional Ethernet, which typically has four wire pairs or conductor pairs per cable, SPE reduces the need for cables, resulting in compact and cost-effective connections. Such a cable preferably has only one wire pair or only one conductor pair. The cable may preferably comprise a twist of the wire pair or the conductor pair. The single wire or conductor pair may be configured to transmit data as well as electrical current or voltage, preferably over distances of up to 1000 meters and/or with a data transmission speed of up to 10 Mbit/s, 100 Mbit/s, or 1 Gbit/s. Furthermore, the cable may be configured to supply a terminal device with electrical current or voltage in accordance with Power over Data Line (PoDL) and to transmit data at the same time. Preferably, the cable and/or the component and/or the connection system may be used or be suitable for use in Industry 4.0, the Internet of Things (IoT), the automotive industry, or building automation. The conductor pair or wire pair preferably comprises or consists of copper or a copper alloy. Preferably, the cable complies with a Single Pair Ethernet cable according to IEEE 802.3bw, preferably in the validity of this standard on December 1, 2024, in particular in the Federal Republic of Germany. Preferably, the cable can be configured for full-duplex communication.

The component may preferably be a Single Pair Ethernet connector (SPE connector), in particular in accordance with the IEC 63171 standard, preferably in accordance with the status as of December 1, 2024, in particular with effect for the Federal Republic of Germany. The component may be particularly preferably configured as a connector or circular connector with M8 or M12 thread. The plug arrangement or socket arrangement of such a connector may have a thread for fastening, in particular to an electrical device or sensor. Furthermore, the cable and/or the component and/or the connection system may be configured to transmit a maximum power of 50 or 60 watts.

The connection system, contacting device, or cable according to the invention preferably has conductors consisting of electrically conductive filler material. In addition or as an alternative, the cable has an electrically insulating filler material which serves to electrically insulate the electrical conductors from the environment of the cable and/or from each other.

The cable may preferably comprise a fluid conduit, in particular for transporting gases or liquids. Alternatively or additionally, the cable may comprise a fluid conduit for transporting a liquid coolant, wherein the coolant is preferably configured to cool the electrical conductors and/or the electrical components. The fluid conduit is preferably configured as a channel extending along the cable.

The cross-section of the cable may taper.

Optionally, the cable, connection system, and/or contacting device is configured for 48-volt applications, in particular for drives, preferably with 48 volts, and complies with the IO-Link Safety protocol or is configured for its implementation.

An aspect of the invention may also be a charging connection with a connection system according to the invention, whereby 500,000 watts can be transmitted by means of the charging connection in particular. The charging connection may comprise the aforementioned fluid line, in particular for cooling.

The invention also relates to a connection system comprising a cable according to the invention and a contacting device according to the invention, wherein preferably the contact means are each electrically contacted with only one specific conductor of the cable, by the contact means being inserted exclusively or predominantly into the contact surface formed at the cable end, wherein the counter-coding of the contacting device interacts with the coding of the cable in such a way that specific contacting of the contact means with the conductors is ensured.

The connection system according to the invention thus offers the same advantages as those described in detail with reference to a contacting device according to the invention and a cable according to the invention.

In other words, the connection system according to the invention may preferably be a connection system comprising a cable and a contacting device, wherein the cable has coding in the form of a continuously extending helical groove or ridge on a sheath of the cable and electrical conductors twisted together, wherein the coding has the same relative position with respect to the electrical conductors along the cable in a plane perpendicular to the direction of extension of the cable, wherein the electrical conductors extend only up to a contact surface formed at one cable end of the cable, wherein the contacting device comprises a plurality of contact means, in particular piercing means, by means of which a respective electrical conductor, in particular a stranded conductor, of the cable is electrically contacted at the contact surface, wherein the contact means, in particular a configuration and/or arrangement and/or direction of extension of the contact means, are configured, depending on the twisting of the conductors, in such a way that a contacting movement, which has led to the electrical conductors being contacted by means of the contact means, in particular predominantly or exclusively, has been performed by the multiple contact means piercing into the electrical conductors, at the contact surface of the cable, wherein the contact means extend to a plane that is perpendicular to the direction of extension of the cable and/or that is perpendicular to an insertion direction of the cable into the contacting device and/or in which the contact surface lies, in particular at an acute angle, wherein the contact means, in particular the configuration and/or arrangement and/or dimensioning and/or direction of extension of the plurality of contact means, are adapted to the electrical conductors, in particular the twisting of the electrical conductors and/or a dimensioning of the electrical conductors and/or a course of the electrical conductors and/or an arrangement of the electrical conductors at the contact surface and/or an extension direction of the electrical conductors at the contact surface, are configured such that electrical contacting of a plurality of electrical conductors by means of only one of the contact means, in particular by one of the contact means electrically contacting a first electrical conductor in the contact surface and a further electrical conductor in the direction of extension of the cable behind or next to the first electrical conductor, preferably due to the twisting of the electrical conductors, wherein the contacting device comprises at least one actuating element and a motion converter, wherein an actuating motion can be initiated in the motion converter by means of the actuating element, wherein the actuating movement is a rotational motion, a pressing motion, pull movement or a swivel movement, wherein the motion converter is configured to convert the initiable actuating movement into a contacting movement in order to contact the contact means with the electrical conductors, wherein the actuating element is configured to be ring-shaped or cylindrical or tubular or as a lever, wherein the contacting device comprises a latching mechanism for the actuating element, by means of which the actuating element is locked in a position, wherein the position corresponds to a penetration depth of the contact means into the cable, wherein the contacting device comprises an indexing means by means of which a penetration depth of the contact means into the cable is indicated, wherein the contacting device comprises an adjustment mechanism by means of which a maximum penetration depth of the contact means into the cable is adjusted, wherein the contacting device comprises a locking mechanism for the cable, by means of which the cable is fixed to the contacting device, wherein the locking mechanism is releasable in order to release the fixing of the cable from the contacting device, wherein the fixing is formed as a force-fitting and/or form-fitting connection of a sheath of the cable with the locking mechanism, wherein actuation of the locking mechanism can preferably be performed by means of the actuating element or a further actuating element, wherein the contacting device comprises at least one seal, preferably a sealing lip, which interacts with the sheath of the cable or with the contact surface of the cable in such a way that contacting points at which the contact means electrically contact the electrical conductors electrically, are sealed off from the environment of the contacting device by means of the seal, wherein the contacting device has a counter-coding for the coding of the cable, wherein the coding and the counter-coding interact in such a way that specific contacting of the contact means with the conductors is ensured and/or contacting of the contact means with the conductors that deviates from specific contacting is excluded.

It is possible that the cable is configured to conduct at least one other medium in addition to electricity. For this purpose, the cable may have at least one additional conductor and/or channel which is intended for conducting at least one fluid such as liquids or gases. The cable may, for example, also be conifugred as a fluid, pneumatic, or hydraulic cable or the like.

The invention also relates to a method for manufacturing a connection system, in particular one of the connection systems according to the invention, comprising:

Providing a cable according to the invention,

Providing a contacting device according to the invention,

Electrically contacting each electrical conductor of the cable with only one contact means corresponding to a specific coding by means of a contacting movement which in particular comprises a movement of the cable in the direction of extension of the cable and simultaneously a rotational movement of the cable about the direction of movement, such that the contact means are inserted exclusively or predominantly into the contact surface formed at the cable end in order to establish the contact.

The method according to the invention thus offers the same advantages as those described in detail with reference to a contacting device, a cable, and a connection system according to the invention.

### BRIEF DESCRIPTION OF THE SEVERAL VIEWS OF THE DRAWINGS

Further advantages, features, and details of the invention are apparent from the following description, in which embodiments of the invention are described in detail with reference to the drawings. The features mentioned in the claims and in the description may be essential to the invention individually or in any combination.

### Showing

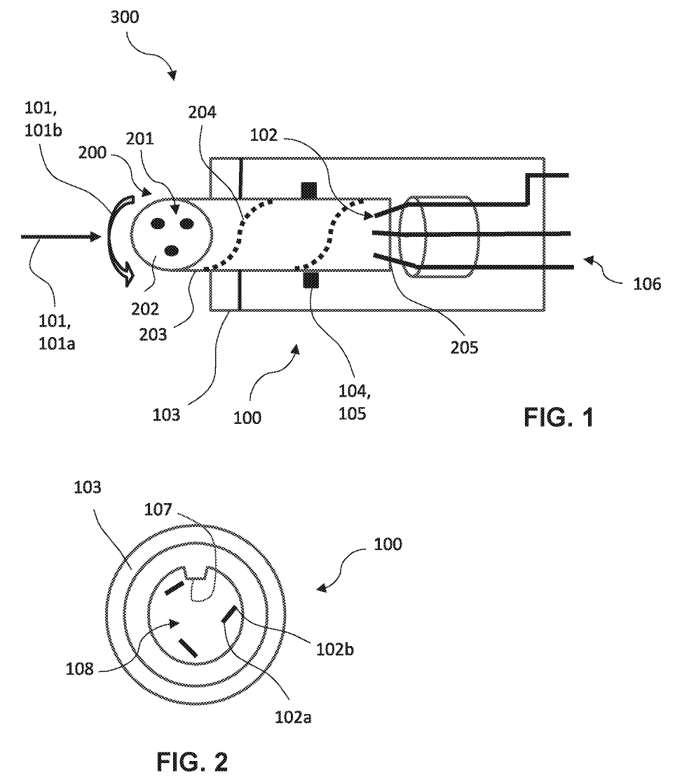

FIG. 1 a schematic representation of an embodiment of a connection system according to the invention,

FIG. 2 a schematic representation of a contacting device of the connection system according to the invention from FIG. 1, and

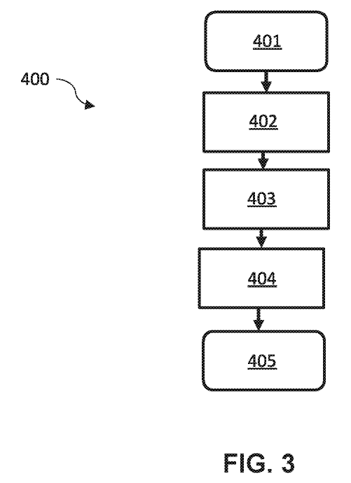

FIG. 3 a flowchart of an embodiment of the method according to the invention for manufacturing the connection system shown in FIG. 1.

### DESCRIPTION OF SPECIFIC EMBODIMENTS OF THE INVENTION

FIG. 1 shows a schematic representation of an embodiment of a connection system 300 according to the invention, comprising a cable 200 according to the invention and a contacting device 100 according to the invention. The cable 200 has coding 204 in the form of a continuously running helical groove or bead on a sheath 203 of the cable 200 and electrical conductors 201 twisted together. Despite the dashed representation of the coding 204, the coding 204 runs continuously, i.e., without interruption, along the cable 200. The conductors 201 are configured as stranded conductors in order to ensure maximum deformability. The coding 204 has the same relative position to the electrical conductors 201 along the length of the cable 200, in a plane perpendicular to the direction of the cable 200. The electrical conductors 201 extend only to a contact surface 205, which defines one end of the cable 200.

The contacting device 100 has a plurality of contact means 102, in particular piercing means 102, by means of which an electrical conductor 201, in particular a stranded conductor, of the cable 200 is electrically contacted at the contact surface 205.

The contact means 102, in particular a configuration and/or arrangement and/or direction of extension of the contact means 102, are configured in dependence on the twisting of the conductors 201 in such a way that a contacting movement, which has led to the contacting of the electrical conductors 201 by means of the contact means 102, in particular predominantly or exclusively, has been carried out by the multiple contact means 102 piercing into the electrical conductors 201 at the contact surface 205 of the cable 200.

The contact means 102 extend to a plane that extends perpendicular to the direction of extension of the cable 200, in particular at an acute angle, wherein the contact means 102, in particular the configuration and/or arrangement and/or dimensioning and/or direction of extension of the plurality of contact means 102, are adapted to the electrical conductors 201, in particular the twisting of the electrical conductors 201 and/or a dimensioning of the electrical conductors 201 and/or a course of the electrical conductors 201 and/or an arrangement of the electrical conductors 201 on the contact surface 205 and/or an extension direction of the electrical conductors 201 on the contact surface 205, are configured such that electrical contacting of several electrical conductors 201 can be achieved by means of only one of the, i.e. in particular the same, contact means 102, in particular by one of the contact means 102 electrically contacting a first electrical conductor 102 in the contact surface 205 and a further electrical conductor 201 in the direction of extension of the cable 200 behind or next to the first electrical conductor 201, preferably due to the twisting of the electrical conductors 201. The contacting device 100 has at least one actuating element 103 and a motion converter, wherein an actuating movement can be initiated in the motion converter by means of the actuating element 103, wherein the actuating movement is a rotational movement, a pressure movement, tensile movement or a pivoting movement, wherein the motion converter is configured to convert the initiable actuating movement into a contacting movement 101 in order to contact the contact means 102 with the electrical conductors 201. The actuating element 103 is configured in a ring shape. The contacting device 100 has a locking mechanism 104 for the cable 200 in order to fixedly attach the cable 200 to the contacting device 100. The locking mechanism 104 is configured to be releasable in order to be able to release the fixing of the cable 200 from the contacting device 100. The fixation is configured as a clamp connection by means of a locking device 105, which acts as a seal 105. The seal 105 serves as strain relief and interacts with the sheath 203 of the cable 200 or with the contact surface of the cable 2000 in such a way that contact points at which the contact means 102 electrically contact the electrical conductors 201 sealed by means of the seal 105 to the environment of the contacting device 100, wherein the contacting device 100 has a counter-coding 107 for a coding 204 of the cable. The coding 204 and the counter-coding 107 interact in such a way that specific contacting of the contact means 102 with the conductors 201 is ensured and/or contacting of the contact means 102 with the conductors 201 that deviates from specific contacting is excluded. The contact means 102 lead electrically conductively to a plug arrangement 106 of the contacting device 100.

FIG. 2 shows a schematic representation of a contacting device 100 according to the invention of the connection system from FIG. 1. Here, a view of the contacting device 100 in the direction of the linear movement for inserting the cable into the contacting device 100, i.e., from the perspective of the front end of the cable, is shown. The actuating element 103 and the insertion opening 108 can be seen, whereby the insertion opening 108 has a counter-coding 107 that matches the coding of the cable. It can also be seen that the contact means 102 do not run parallel to each other, but at an angle to an axis defined by the linear movement, as the contact means tips 102a and the contact means bases 102b of the three contact means 102 are visible at the same time. The contact means tips 102a are configured as piercing tips to facilitate the piercing of the contact means 102 into the conductors of a cable.

Due to the two-dimensional representation in FIG. 2, it must be viewed in conjunction with FIG. 1 to clarify that, according to embodiments of the invention, the contact means tips 102a of the contact means 102 are arranged closer to the cable or conductor when piercing than the associated contact means bases 102b. The contact means feet 102b can thus be attached to a base of the contacting device 100, and the contact means 102 can extend away from the base at an angle which is defined, for example, as a function of a twist of the conductors of the cable, so that the contact means tips 102a are arranged at a corresponding distance from the base.

The alignment of the contact means 102 allows the contact means to extend along the conductors that are twisted relative to each other.

FIG. 3 shows a flowchart of an embodiment of the method 400 according to the invention for manufacturing the connection system from FIG. 1. First, a first process step 401 is performed, which comprises initializing the method 400 according to the invention. This is followed by a second process step 402, which comprises providing a cable according to the invention. Next, a third process step 403 is performed, which comprises providing a contacting device according to the invention. This is followed by a fourth process step 404, which comprises electrically contacting each electrical conductor of the cable with only one contact means corresponding to a specific coding. This is done by means of a contacting movement of the cable such that the contact means are inserted exclusively or predominantly into the contact surface formed at the cable end in order to establish the contact. The contacting movement comprises a movement of the cable in the direction of extension of the cable and, at the same time, a rotational movement of the cable about the direction of movement. In other words, it is a screw movement. As a fifth and thus final process step 405, the process is then terminated, thereby completing the production of the connection system.

### REFERENCE NUMERALS

100 Contacting device

101 Contacting movement

101a Linear movement

101b Rotational movement

102 Contact means, piercing means

102a Contact means tip

102b Contact means base

103 Actuating element

104 Locking mechanism

105 Locking means, seal

106 Plug arrangement

107 Counter-coding

108 Insertion opening

200 Cable

201 Conductor

202 Cable cross-section

203 Sheath

204 Coding

205 Contact surface

300 Connection system

400 Method

401 First method step

402 Second method step

403 Third method step

404 Fourth method step

405 Fifth method step

What is claimed is:

1. A contacting device (100) for specific electrical contacting of electrical conductors (201) of an electrical cable (200) that are twisted together,
wherein the contacting device (100) comprises a plurality of contact means (102) for electrically contacting each electrical conductor (201) of the cable (200) by means of one of the contact means (102) at a contact surface (205) which is formed at an end of the cable (200),
wherein the contact means (102) are configured in such a way that a contacting movement (101) for contacting the electrical conductors (201) by means of the contact means (102), is initiated by the multiple contact means (102) piercing the electrical conductors (201) at the contact surface (205) of the cable (200).

2. The contacting device (100) according to claim 1,
wherein the contact means extend to a plane that is perpendicular to the direction of extension of the cable (200) and/or perpendicular to an insertion direction of the cable (200) into the contacting device (100) and/or in which the contact surface (205) lies.

3. The contacting device (100) according to claim 1,
wherein the contacting movement (101) comprises a movement of the cable relative to the contacting device (100) in the direction of extension of the cable (200) and/or in the direction of insertion of the cable (200) into the contacting device (100), and that the contacting movement (101) simultaneously comprises a movement of the cable (200) relative to the contacting device (100) about the direction of extension of the cable (200) and/or about the direction of insertion of the cable (200) into the contacting device (100).

4. The contacting device (100) according to claim 1,
wherein
the contact means (102) are adapted to the electrical conductors (201),
such that electrical contacting of a plurality of electrical conductors (201) by means of only one of the contact means (102) is prevented.

5. The contacting device (100) according to claim 1,
wherein
the contact means (102) have an extension direction and/or arrangement which is configured in such a way that, when the contact means (102) penetrate the electrical conductors (201) at the contact surface (205) during the contacting movement (101), the contact means (102) can essentially form an extension of the electrical conductors (201) adjacent to the contact surface (205).

6. The contacting device (100) according to claim 1,
wherein the contacting device (100) comprises at least one actuating element (103) and a motion converter,
wherein an actuating movement can be initiated in the motion converter by means of the actuating element (103),
wherein the actuating movement is a rotational movement, a pressing movement, a pulling movement, or a pivoting movement,
wherein the motion transducer is configured to convert the initiable actuating movement into the contacting movement (101) in order to contact the contact means with the electrical conductors (201).

7. The contacting device (100) according to claim 1,
wherein the contacting device (100) comprises a detent mechanism for an actuating element (103), by means of which the actuating element (103) can be latched in at least one position, wherein the at least one position corresponds to a penetration depth of the contact means (102) into the cable (200).

8. The contacting device (100) according to claim 1,
wherein
the contacting device (100) comprises a locking mechanism (104) for the cable (200).

9. The contacting device (100) according to claim 1,
wherein the contacting device (100) comprises at least one seal (105) to interact with a sheath (203) of the cable (200) or with the contact surface (205) of the cable (200) in such a way that contacting points at which the contact means (102) are capable of making electrical contact with the electrical conductors (201), can be sealed by means of the seal (105) to the environment of the contacting device (100) when the electrical contact between the electrical conductors (201) and the contact means (102) is established.

10. The contacting device (100) according to claim 1,
wherein the contacting device (100) is configured as a plug connector or as an electrical connection of an electrical component.

11. The contacting device (100) according to claim 1,
wherein
the contacting device (100) has a counter-coding (107) for a coding (204) of the cable (200),
wherein the coding (204) and the counter-coding (107) interact in such a way that a specific contacting of the contact means (102) with the conductors (201) is ensured and/or contacting of the contact means (102) with the conductors (201) that deviates from specific contacting is prevented.

12. A cable (200) for the contacting device (100) according to claim 1 comprising a coding (204),
wherein the coding (204) is mounted along the cable (200) and has the same relative position to the electrical conductors (201) in a plane perpendicular to the direction of extension of the cable (200).

13. A connection system (300) comprising a cable (200) and a contacting device (100) according to claim 1,
wherein
the contact means (102) are each electrically contacted with only one specific conductor (201) of the cable (200), by the contact means (102) being inserted exclusively or predominantly into the contact surface (205) formed at the cable end,
wherein a counter-coding (107) of the contacting device (100) interacts with the coding (204) of the cable (200) in such a way that specific contacting of the contact means (102) with the conductors (201) is ensured.

14. A connection system (300) comprising a cable (200) and a contacting device (100),
wherein the cable has a coding (204) in the form of a continuously extending helical groove or ridge on a sheath (203) of the cable (200) and electrical conductors twisted together (201),
wherein the coding (204) has the same relative position with respect to the electrical conductors (201) along the cable (200) in a plane perpendicular to the direction of extension of the cable (200),
wherein the electrical conductors (201) extend only up to a contact surface (205) formed at one cable end of the cable (200),
wherein the contacting device (100) comprises a plurality of contact means (102) by means of which a respective electrical conductor (201) of the cable (200) is electrically contacted at the contact surface (205),
wherein the contact means (102) are configured, depending on the twisting of the conductors (201), in such a way that a contacting movement (101), which has led to the electrical conductors (201) being contacted by means of the contact means (102) has been performed by the multiple contact means (102) piercing into the electrical conductors (201), at the contact surface (205) of the cable (200),
wherein the contact means (102) extend to a plane that is perpendicular to the direction of extension of the cable (200) and/or that is perpendicular to an insertion direction of the cable (200) into the contacting device (100) and/or in which the contact surface (205) lies,
wherein the contact means (102) are adapted to the electrical conductors (201) such that electrical contacting of a plurality of electrical conductors (201) by means of only one of the contact means (102) by one of the contact means (102) electrically contacting a first electrical conductor (201) in the contact surface (205) and a further electrical conductor (201) in the direction of extension of the cable (200) behind or next to the first electrical conductor (201),
wherein the contacting device (100) comprises at least one actuating element (103) and a motion converter,
wherein an actuating motion can be initiated in the motion converter by means of the actuating element (103),
wherein the actuating movement is a rotational motion, a pressing motion, pull movement or a swivel movement,
wherein the motion converter is configured to convert the initiable actuating movement into a contacting movement (101) in order to contact the contact means (102) with the electrical conductors (201),
wherein the actuating element (103) is configured to be ring-shaped or cylindrical or tubular or as a lever,
wherein the contacting device (100) comprises a latching mechanism for the actuating element (103), by means of which the actuating element (103) is locked in a position, wherein the position corresponds to a penetration depth of the contact means (102) into the cable (200),
wherein the contacting device (100) comprises an indexing means by means of which a penetration depth of the contact means (102) into the cable (200) is indicated,
wherein the contacting device (100) comprises an adjustment mechanism by means of which a maximum penetration depth of the contact means (102) into the cable (200) is adjusted,
wherein the contacting device (100) comprises a locking mechanism (104) for the cable (200), by means of which the cable (200) is fixed to the contacting device (100),
wherein the locking mechanism (104) is releasable in order to release the fixing of the cable (200) from the contacting device (100),
wherein the fixing is formed as a force-fitting and/or form-fitting connection of a sheath (203) of the cable (200) with the locking mechanism (104),
wherein the contacting device (100) comprises at least one seal (105) which interacts with the sheath (203) of the cable (200) or with the contact surface (025) of the cable (200) in such a way that contacting points at which the contact means (102) electrically contact the electrical conductors (200) electrically, are sealed off from the environment of the contacting device (100) by means of the seal (105),
wherein the contacting device (100) has a counter-coding (107) for the coding (204) of the cable (200),
wherein the coding (204) and the counter-coding (107) interact in such a way that specific contacting of the contact means (102) with the conductors (201) is ensured and/or contacting of the contact means (102) with the conductors (201) that deviates from specific contacting is excluded.

15. A method for manufacturing a connection system (300) according to claim 13, comprising:
providing the cable (200),providing the contacting device (100),
electrically contacting each electrical conductor (201) of the cable (200) with only one contact means (102) corresponding to a specific coding (204) by means of a contacting movement (101), such that the contact means (102) are inserted exclusively or predominantly into the contact surface (205) formed at the cable end in order to establish the contact.
